(19) United States
(12) Patent Application Publication
(10) Pub. No.: US 2006/0087218 A1
(43) Pub. Date: Apr. 27, 2006

(54) Display device and method for manufacturing the same

(76) Inventors: Yoshiro Mikami, Hitachi (JP); Yukio Takasaki, Mobara (JP); Masahiro Tanaka, Mobara (JP); Masakazu Sagawa, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/252,794

(22) Filed: Oct. 19, 2005

(30) Foreign Application Priority Data
Oct. 21, 2004 (JP) 2004-307349

(51) Int. Cl. H01J 63/04; H01J 1/62

(52) U.S. Cl. 313/495; 313/496; 313/311

(57) ABSTRACT

Both a display device for displaying a uniform image on the front surface of a FED panel, and a method for manufacturing the same are disclosed. The display device includes a glass substrate which forms thereon signal wirings and MIM elements connected to thin-film scanning wirings, and an opposed substrate which forms thereon phosphor layers for performing light emissions by electron beams from the MIM elements. In the display device and the method for manufacturing the same, low-resistance wiring patterns formed separately on a film substrate are transferred onto the thin-film scanning wirings and upper electrodes. This transfer allows low-resistance scanning-wiring buses to be fixedly bonded thereon by electrically-conductive adhesive layers.

### BACKGROUND OF THE INVENTION

1. Field of the Invention

The present invention relates to a display device for displaying an image by causing a fluorescent surface to emit light with the use of an electron beam, and a method for manufacturing the same display device. Here, the electron beam is emitted from a plurality of electron emission elements which are arranged in a matrix-like manner.

2. Description of the Related Art

The FED (: Field Emission Display) display device uses, as electron emission elements, the current-driving-type electron emission elements such as the MIM (: Metal/Insulator/Metal) and the SED (: Surface conductive electron Emission Display) Moreover, the FED display device drives based on the line-sequential scanning scheme, where scanning wirings are sequentially selected and are caused to emit light. In the line-sequential scanning scheme, peak current of the scanning wirings is equal to 100 mA to 200 mA. This is because all the currents of MIM pixels by the amount of a single scanning wiring flow along the scanning wirings simultaneously.

The voltage gradation scheme as gradation control scheme for the MIM pixels exhibits an advantage that the driving circuit becomes simpler and also only a small voltage suffices for the driving circuit. Voltage drop in a scanning wiring, however, causes voltage drop to occur starting from end portion of the scanning wiring up to central portion thereof. This voltage drop drops voltage of the MIM pixels in the central portion, thereby eventually lowering luminance in the central portion.

Concretely, if resistance of the scanning wiring is equal to 10 Ω, the voltage drop becomes equal to 1 V to 2 V. Moreover, the MIM luminance modulation voltage range, i.e., the voltage range corresponding to the white-black gradation, is equal to substantially 3 V at the highest. This situation results in a tremendous lowering in the luminance in the central portion.

Furthermore, if high-definition implementation of the pixels has been performed to increase the MIM-pixel number connected to the scanning wiring, when heightening the luminance, the current flowing along the scanning wiring increases. Also, when the scanning wiring is prolonged because of up-sizing of the FED panel, the resistance of the scanning wiring increases. From the reasons described above, the voltage drop becomes conspicuous. This results in the lowering in the luminance distribution within the surface. In this way, in the MIM FED, it is of extreme importance that the scanning wiring exhibits the low resistance.

Conventionally, as the scanning wirings, metal films are formed using a method such as sputtering. In this case, however, the metal films need to be formed considerably thick, i.e., 1 μm to 10 μm thick. This condition requires a considerable time for the film-forming time and etching, and also makes the cost higher.

In JP-A-2002-33061, in order to reduce the resistance of the scanning wirings, the following FED display device has been disclosed: Namely, a metallic copper foil is etched, thereby forming stripe metallic-foil wirings whose pitch is the same as that of the scanning-wiring patterns. Next, the stripe metallic-foil wirings are overlaid on the scanning wirings, and are then imposed thereon by spacers. This processing makes the stripe metallic-foil wirings electrically conductive with the scanning wirings.

Also, in JP-A-7-323654, the following method has been disclosed: Namely, a character pattern of 20-μm to 300-μm-thick electrically-evaporated thin film is formed on a film-like support substrate. Next, this character pattern is transferred onto a clock-use display plate.

### SUMMARY OF THE INVENTION

In JP-A-2002-33061, no description has been given concerning the following problems (1) to (7):

(1) In a state where a tension is added to 0.1-mm to 0.15-mm-film-thick stripe metallic-foil wirings, the thick film-thickness stripe metallic-foil wirings are overlaid on the scanning wirings. Accordingly, there exists a possibility that a discharge unnecessarily occurs from an anode to the thick film-thickness stripe metallic-foil wirings.

(2) The stripe metallic-foil wirings and the scanning wirings are brought into close contact with each other by being imposed on each other by the spacers. This requires that the spacers be located on all of the stripe metallic-foil wirings.

(3) Edges of the stripe metallic-foil wirings imposed and pressed by the spacers are not brought into close contact with the scanning wirings. Namely, the edges are apart from the scanning wirings, and have a configuration of protruding into vacuum space. Accordingly, there exists a possibility that a discharge unnecessarily occurs from the high-voltage anode by electric-field concentration, and that the discharge destructs a power supply or a scanning-wiring driving circuit.

(4) The stripe metallic-foil wirings are imposed and pressed by the spacers in the vacuum space. Accordingly, the stripe metallic-foil wirings are not imposed and pressed at terminal portions other than vacuum sealing portions. On account of this, the terminal portions and an external circuit are not connected with each other with a low resistance implemented therebetween.

(5) Since the stripe metallic-foil wirings are fixed by the spacers, the stripe metallic-foil wirings are not fixed at the begging of the panel assembly operation. Consequently, the panel assembly operation becomes complicated. For example, during an operation of locating and fixing the spacers, attention is required so that no position shift will occur between the stripe metallic-foil wirings or the scanning wirings and the spacers.

(6) The spacers and the stripe metallic-foil wirings are brought into contact with each other by being imposed on each other. Accordingly, the electrically conductive contact therebetween cannot be said to be sufficient. Consequently, there exists a possibility that the high voltage applied to an anode substrate charges the spacers undesirably, and thereby hinders straight-ahead movement of the electron beam.

(7) The spacers are narrower than the scanning-wiring width, and the stripe metallic-foil wirings are in contact with the scanning wirings only in a part of the scanning-wiring width. Consequently, there exists a possibility that currents are concentrated onto the contact portions, and thereby currents flowing along the stripe metallic-foil wirings and the scanning wirings will not become uniform.

Also, in JP-A-7-323654, no description has been given concerning the following configurations: A large number of scanning-wiring bus patterns are aligned with a high accuracy so that the scanning-wiring bus patterns will be transferred and formed in batch. Also, the scanning-wiring buses and the thin-film scanning wirings are made electrically conductive with each other. Moreover, these configurations are applied to a display device where a plurality of electron emission elements are arranged.

Accordingly, it is an object of the present invention to provide a display device for displaying a uniform image on the front surface of the FED panel, and a method for manufacturing the same display device. Here, this provision is implemented by transferring in batch a plurality of low-resistance wiring patterns formed on a film substrate, and fabricating the in-batch transferred wiring patterns as the scanning wirings for selecting the plurality of electron emission elements.

With adhesive layers, the large number of scanning-wiring buses are pasted onto a glass substrate on which signal wirings and the MIM elements have been formed. This allows formation of the FED panel including the low-resistance scanning wirings.

These large number of scanning-wiring buses are formed as follows: First, the large number of wiring patterns are formed in batch on the film substrate by selectively plating a low-resistance metal. Next, using the adhesive layers further formed on the surfaces of the wiring patterns, the scanning-wiring buses are formed based on the transfer method. This method allows the scanning-wiring buses falling in the not-discharging thickness range (i.e., 20 μm to 300 μm thick) to be formed in a state of being brought into close contact with the surfaces of the thin-film scanning wirings i.e., the grounds. This accomplishment, further, makes it possible to form the no-discharge and high-reliability FED panel.

Also, when configuring the scanning wirings by using only the scanning-wiring buses, non-metallic inorganic component such as low-melting glass is mixed into the adhesive layers. This makes it possible to acquire the high-reliability scanning wirings characterized by solid pasting, simple configuration, and easy assembly.

When forming the wiring patterns on the film substrate, the wiring patterns are formed with a pitch which is somewhat narrower than the thin-film scanning-wiring pitch on the glass substrate. Furthermore, while enlarging the film substrate in the pitch direction of the wiring patterns, the pitch and positions of the wiring patterns and those of the thin-film scanning wirings are aligned using an alignment mark provided on the film substrate and a target mark provided on the glass substrate.

The large number of scanning-wiring buses can be transferred and formed in batch on the thin-film scanning wirings. Also, resistance of the scanning wiring including the scanning-wiring bus and the thin-film scanning wiring is low enough. For example, in a 40-inch-diagonal and 720-pixel×1280-pixel large-sized FED panel, in the case of a 600-μm-scanning-wiring-wide and 80-μm-film-thick Cu wiring, the low-resistance scanning wirings one of which has 0.5-Ω-or-less resistance can be transferred and formed in batch.

Incidentally, in FED panels whose diagonal sizes exceed 20 inches, when acquiring the definition degree that resolution is more than XGA (extended Graphic Array), 10-%-or-less current emission efficiency, and 500-cd/m²-or-more luminance, in a 100-μm-or-less-scanning-wiring-wide FED panel, in a 5-μm-or-less-film-thick aluminum (Al) wiring or a 3-μm-or-less-film-thick copper (Cu) wiring, current density of the wiring exceeds 10⁻⁵ A/cm². Accordingly, occurrence of the electro migration results in short-circuit or disconnection of the scanning wiring, thereby lowering the reliability exceedingly. The present invention, however, makes it possible to eliminate this occurrence, and to enhance the reliability significantly.

Also, the entire surface of the scanning-wiring bus width is brought into contact with the thin-film scanning wiring. Moreover, either of the thin-film scanning wiring and the scanning-wiring bus has a uniform current distribution within the cross section. Accordingly, it is possible to establish connection with the stable low resistance over the entire region of the scanning wiring. This gives rise to no occurrence of the electro migration, thereby making it possible to form the scanning-wiring structure with excellent life-expectancy and reliability.

Moreover, the scanning-wiring buses are brought into close contact with the thin-film scanning wirings by the adhesion. Consequently, there exists no discharge from the high-voltage anode.

Also, the scanning-wiring buses are fixed on the thin-film scanning wirings, or the scanning-wiring bus is fixed on the substrate alone. This allows implementation of a high reliability of the terminal portions in the vacuum sealing regions, and also allows the terminal portions to be connected with an external circuit without fail.

Furthermore, the thin-film scanning wirings and the scanning-wiring buses are fixed with each other by the adhesion. Accordingly, there exists no necessity for imposing the scanning-wiring buses by the spacers. Consequently, it is satisfying enough to locate the spacers on arbitrary scanning wirings alone. This makes it possible to significantly reduce quantity of the spacers in number, and to significantly reduce the number of the configuration components.

Also, the spacers and the scanning-wiring buses are brought into contact with each other via the adhesive layers. This makes it possible to prevent the spacers from being charged, thereby allowing the electron beam to move straight ahead satisfactorily.

In addition, during the operation of locating and fixing the spacers, the scanning-wiring buses in the display region are fixed. Consequently, no position shift will occur between the scanning-wiring buses and the spacers during the operation. This allows implementation of the high-accuracy assembly, and also allows the assembly operation to be easily executed.

As explained so far, according to the present invention, in the large-sized, high-definition, and high-luminance FED panel, it becomes possible to implement the reduction in the scanning-wiring resistance. This accomplishment allows implementation of the reduction in the scanning-wiring current density, thereby making it possible to enhance the life-expectancy and reliability.

### BRIEF DESCRIPTION OF THE DRAWINGS

FIG. 1 is a schematic diagram of cross-sectional structure of the FED panel according to the present invention;

FIG. 2 is a schematic diagram of cross-sectional structure of the FED display device according to the present invention;

FIG. 3 is an enlarged diagram of a pixel portion 45 illustrated in FIG. 2;

FIG. 4 is a cross-sectional diagram along A-A′ line in FIG. 3;

FIG. 5 is a cross-sectional diagram along B-B′ line in FIG. 3;

FIG. 6 is a cross-sectional diagram along C-C′ line in FIG. 3;

FIG. 7 is a configuration diagram of a film substrate 70 according to the present invention;

FIG. 8 is a cross-sectional diagram of wiring patterns 71;

FIG. 9 is a transfer process diagram of the wiring patterns 71;

FIG. 10 is a transfer process diagram using metallurgical tools;

FIG. 11 is a configuration diagram where structure of a thin-film scanning wiring 14 is simplified;

FIG. 12 is a simplified structure diagram where the thin-film scanning wiring 14 is configured with a scanning-wiring bus 21 alone;

FIG. 13 is a configuration diagram of the low-resistance scanning-wiring bus 21;

FIG. 14 is a plan view of the pixel portion 45 illustrated in FIG. 2, where the low-resistance scanning-wiring bus 21 is located;

FIG. 15 is a cross-sectional diagram along A-A′ line in FIG. 14;

FIG. 16 is a cross-sectional diagram along B-B′ line in FIG. 14;

FIG. 17 is a cross-sectional diagram along C-C′ line in FIG. 14;

FIG. 18 is a cross-sectional diagram in the case where heat-resistant adhesive layers 82 in FIG. 16 are made thicker;

FIG. 19 is a cross-sectional diagram of metallic separation layers 91 and glutinous layers 92 as a separation structure; and

FIG. 20 is a cross-sectional diagram of phosphor separation layers 95 and adhesive layers 96.

### DETAILED DESCRIPTION OF THE INVENTION

Hereinafter, referring to the drawings, the explanation will be given below concerning embodiments of the present invention.

### Embodiment 1

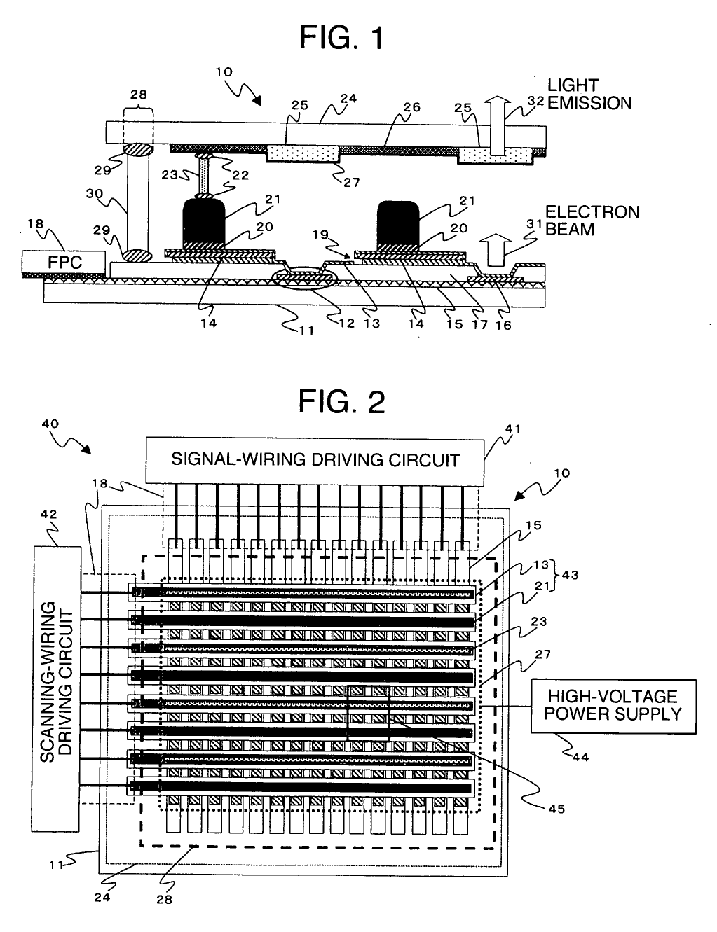

FIG. 1 is cross-sectional structure of a FED panel 10, where a large number of pixels including MIM elements 12 are formed in a matrix-like manner on a glass substrate 11.

Upper electrodes 13 of the MIM elements 12 are formed in such a manner as to cover thin-film scanning wirings 14. MIM insulating layers 16 are formed between the upper electrodes 13 and signal wirings 15 as lower electrodes of the MIM elements 12.

The signal wirings 15 and the thin-film scanning wirings 14 are isolated with each other by inter-layer insulating layers 17, and are connected to the outside of the FED panel 10 via a FPC (: Flexible Print Circuit) 18.

Each thin-film scanning wiring 14 includes a two-layered electrically-conductive layer having an over-hang structure between the upper electrodes 13 and the thin-film scanning wiring 14. By evaporating the upper electrodes 13 of the MIM element 12 onto the thin-film scanning wiring 14 with a separation portion 19 having the over-hang structure, each upper electrode 13 will cover each thin-film scanning wiring 14 in a self-aligning manner. Accordingly, each upper electrode 13 is formed independently without being brought into contact with each thin-film scanning wiring 14 which is separated by this separation portion 19 and is covered by an upper electrode adjacent thereto.

Each low-resistance scanning-wiring bus 21 having each electrically-conductive adhesive layer 20 according to the present invention is located on each thin-film scanning wiring 14 covered by each upper electrode 13. Moreover, each spacer 23 is located on each scanning-wiring bus 21 on each scanning-wiring-bus basis via spacer adhesive agents 22. Also, each spacer 23 is brought into close contact with and is fixed to an opposed substrate 24 via the upper spacer adhesive agent 22.

Also, phosphor layers 25 are formed on the opposed substrate 24 in a manner of being opposed to the MIM elements 12. A black matrix 26 is formed on a region other than the phosphor layers 25. An anode 27 is formed on the phosphor layers 25 and the black matrix 26.

The opposed substrate 24 and the glass substrate 11 are brought into close contact with and is fixed to each other via sealing adhesive agents 29 in a peripheral sealing region 28 and a frame spacer 30.

The inside of the FED panel is maintained under high vacuum. A pulse voltage is applied between the thin-film scanning wirings 14 and the signal wirings 15, thereby causing currents to flow through the MIM elements 12. This allows emissions of electron beams 31 into the vacuum. Furthermore, a 3-kV to 20-kV voltage is applied to the anode 27, thereby accelerating the electron beams 31 and irradiating the phosphor layers 25 with the electron beams 31. This allows acquisition of light emissions 32 from the phosphor.

FIG. 2 is a schematic configuration of a FED display device 40 configured using the FED panel 10. First, a signal-wiring driving circuit 41 and a scanning-wiring driving circuit 42 provided in the surroundings of the FED panel 10 are respectively connected to the large number of signal wirings 15 and a large number of scanning wirings 43 intersecting with these signal wirings 15. Moreover, signals corresponding to the scanning wirings 43 selected by the scanning-wiring driving circuit 42 are supplied by the signal-wiring driving circuit 41 via the signal wirings 15. This allows the MIM elements 12 connected to the signal wirings 15 and the scanning wirings 43 to be driven based on the line-sequential scheme. Also, a high-voltage power supply 44 connected to the anode 27 applies the acceleration voltage.

Each scanning wiring 43 is of a multi-layered structure including each thin-film scanning wiring 14, each upper electrode 13, and each low-resistance scanning-wiring bus 21. Furthermore, the scanning wirings 43 are extracted up to the end portion of the glass substrate 11, and are connected to the scanning-wiring driving circuit 42 via the FPC 18. This configuration makes it possible not only to implement the low-resistance scanning wirings 43 themselves, but also to establish a low-resistance connection between the scanning-wiring driving circuit 42 and the FED panel 10. FIG. 3 illustrates an enlarged diagram of a pixel portion 45.

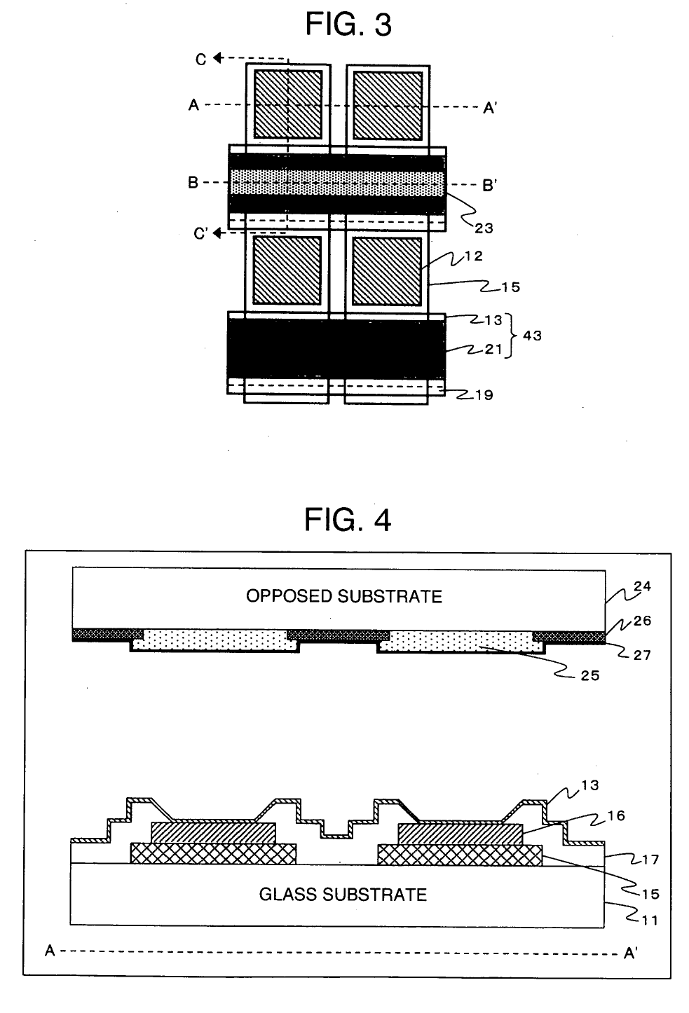

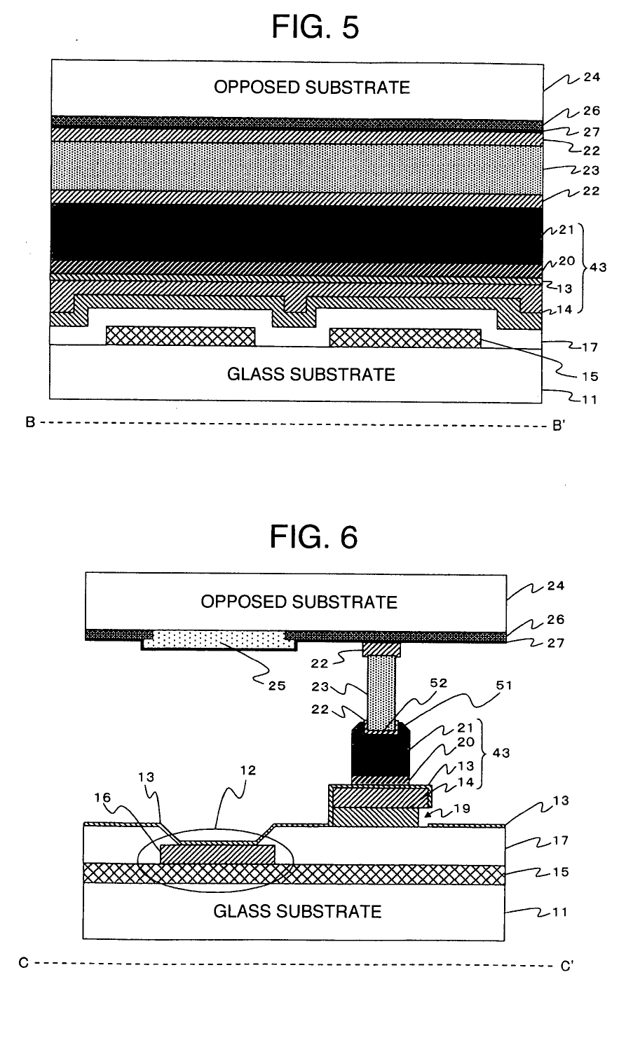

FIG. 3 is an upper-surface diagram of the pixel portion 45, where the MIM elements 12 are located on the signal wirings 15, and where the scanning wirings 43 are located in such a manner as to be perpendicular thereto. FIG. 4, FIG. 5, and FIG. 6 illustrate cross-sectional diagrams along lines A-A′, B-B′, and C-C′, respectively.

FIG. 4, FIG. 5, and FIG. 6 are the cross-sectional structures of the A-A′, B-B′, and C-C′ portions illustrated in FIG. 3, where the reference numerals explained in FIG. 1 and FIG. 2 are used. In particular, as illustrated in FIG. 6, upper-surface angle portion 51 of each scanning-wiring bus 21 is rounded. This allows relaxation of an electric field generated by each high-height scanning-wiring bus 21, thereby making it possible to prevent discharge from the anode 27. Also, a groove portion 52 is provided on the upper side of each scanning-wiring bus 21 in the longitudinal direction. This makes it possible to locate each spacer 23 stably.

Here, the explanation will be given below concerning outline of a manufacture process of manufacturing the glass substrate 11. First, using a sputtering method, a 300-nm-thick aluminum (Al) thin film is formed on the glass substrate 11. Then, based on a photolithography method, the aluminum thin film is machined using a wet etching method, thereby forming the signal wirings 15.

Next, a SiN thin film is formed using the sputtering method or a plasma CVD (: Chemical Vapor Deposition) method. After that, the portions of the MIM elements 12 are formed as apertures. The MIM insulating layers 16 are formed as aluminum oxide layers by anode-oxidizing the aperture portions of the SiN thin film on the signal wirings 15, or by the sputtering film-forming and the photolithography machining method.

Next, the thin-film scanning wirings 14 are formed. In each thin-film scanning wiring 14, the lower layer is composed of Cr, and the upper layer is composed of Al. Incidentally, a three-layered structure is allowable where a thin film of Cr, Mo, W and an alloy of these is further added. If substance such as flit glass is used as the sealing adhesive agent, the Cr layer exhibits excellent matching with the flit glass. Accordingly, the Cr layer is added onto the surface. This allows implementation of stable and excellent sealing, thereby making it possible to enhance vacuum degree of the inside of the panel and to prevent the discharge. The machining is performed using the photolithography method.

Still next, the upper electrodes 13 composed of Ir and Au are formed using the sputtering method. Each thin-film scanning wiring 14 is of the two-layered structure, and has the separation portion 19 where wiring width of the lower layer is narrower than that of the upper layer. The utilization of this difference between the widths cuts the upper electrodes 13 by the over-hang structure. This step-height cutting permits implementation of the configuration where the upper electrodes 13 are separated on each scanning-wiring-43 basis. The separation portion 19 like this can be formed using the wet etching method.

Moreover, using the electrically-conductive adhesive layers 20, the scanning-wiring buses 21 are bonded onto the thin-film scanning wirings 14 on the side of the glass substrate 11 formed as explained above. The scanning-wiring buses 21, which are thicker than the thin-film scanning wirings 14, are equal to 20 μm to 300 μm thick. Also, the scanning-wiring buses 21 are composed of a low-resistance metal formable by electro deposition or plating, such as Cu, Ni, Ag, and Au.

Incidentally, as the material of the scanning-wiring buses 21, an alloy is desirable whose expansion ratio is substantially the same as that of the glass substrate 11. By using a Ni, Fe, and Co alloy and an alloy implemented to exhibit the low resistance by adding Cu, Ag, and Au thereto, a low-expansion and low-resistance alloy is used as the above-described material. This prevents occurrence of warp or exfoliation of the glass substrate 11 during high-temperature processes at the assembly steps.

Also, as the electrically-conductive adhesive layers 20, a material is used which exhibits adhesive property at the time of bonding, is capable of temporary fixing, and is capable of stable fixed-bonding by being solidified at the high-temperature steps later on. For example, a material is usable which is acquired by adding an organic or inorganic binder to a mixture of electrically-conductive particles and the flit glass.

The binder component allows the electrically-conductive adhesive layers to exhibit the adhesive property at the time of pasting. This makes it possible to easily fix the scanning-wiring buses 21 onto the thin-film scanning wirings 14. After the firing formation, evaporation of the binder allows an enhancement in the electrically-conductive property, and also the flit component allows an even stronger fixing. Fine particles of a metal such as Ag, Au, Cu, and Ni are preferable as the electrically-conductive particles. Substance such as resin and water glass is preferable and usable as the binder.

At the time of assembling the FED panel 10, first, the spacer adhesive layers 22 having electrical conductivity are coated on the opposed substrate 24. After that, the adhesive layers 22 are melted and solidified at the high temperature, thereby causing the spacers 23 to be bonded on the opposed substrate 24.

Finally, the spacer adhesive layers 22 are coated on the upper surfaces of the spacers 23 on the opposed substrate 24. The position alignment is performed with the glass substrate 11, and the pasting is performed in a state where the spacers 23 are brought into contact with the scanning-wiring buses 21 via the spacer adhesive layers 22. Then, the spacer adhesive layers 22, the scanning-wiring buses 21, and the sealing adhesive agents 29 of the frame spacer 30 are melted at the high temperature, thereby implementing the bonding. This allows completion of the FED panel 10. Furthermore, the driving circuit 41 and the driving circuit 42 are connected to each other by the FPC 18, and also the high-voltage power supply 44 is connected thereto. This allows completion of the FED display device 40.

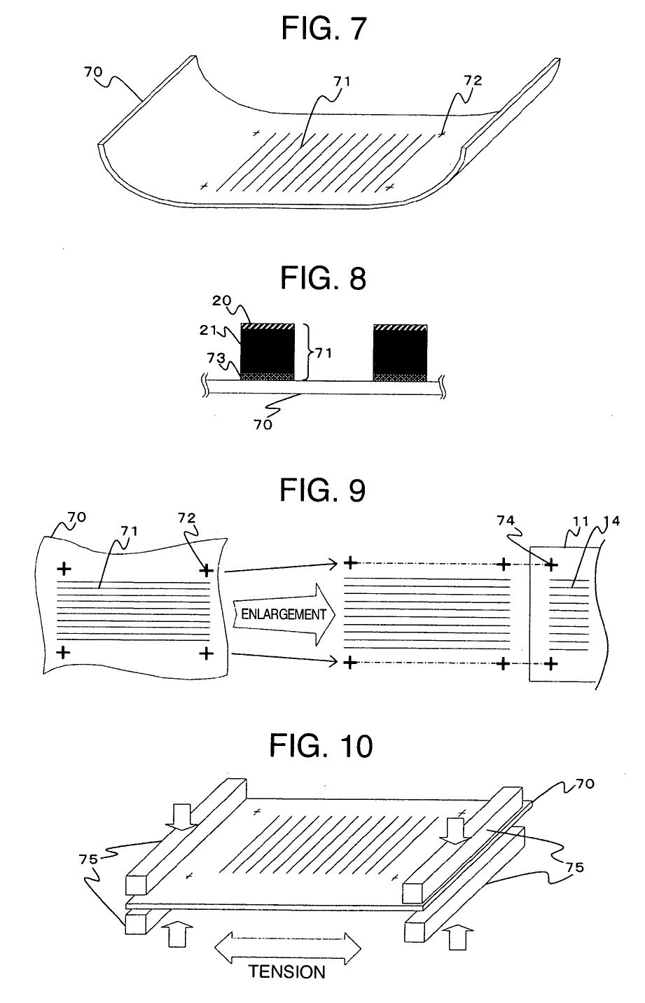

FIG. 7 to FIG. 10 are explanatory diagrams for explaining processes of transferring wiring patterns thereby to form the scanning-wiring buses 21. FIG. 7 is a configuration diagram of a film substrate 70 on which stripe-like wiring patterns 71 and alignment marks 72 are formed.

FIG. 8 is a cross-sectional diagram of the wiring patterns 71. Each wiring pattern 71 is of a multi-layered structure formed on the film substrate 70 and including each temporary-fixing adhesive fixed layer 73, each scanning-wiring bus 21, and each electrically-conductive adhesive layer 20.

It is necessary to paste the wiring patterns 71 with a 10-μm-or-less error with reference to the thin-film scanning wirings 14 formed on the glass substrate 11. The film substrate 70, however, expands and contracts depending on temperature and external force. This requires that the position accuracy be enhanced. Hereinafter, the explanation will be given below concerning a method for implementing the pasting with a high accuracy.

As Illustrated in FIG. 9, the alignment marks 72 and the wiring patterns 71 to be formed on the film substrate 70 are formed such that, in the pitch direction of the wiring patterns 71, the alignment marks 72 and the wiring patterns 71 are slightly narrower than the patterns of the thin-film scanning wirings 14 formed on the glass substrate 11. Then, by enlarging the film substrate 70 in the pitch direction of the wiring patterns 71, the alignment and the pasting are performed so that the alignment marks 72 will be overlaid on target marks 74 provided on the glass substrate 11. This makes it possible to implement the position alignment and the pasting in the pitch direction with a high accuracy.

At the time of the pasting, as illustrated in FIG. 10, the stretch of the film substrate 70 is implemented by the following mechanism: Namely, using a jig tool 75, both ends of the film substrate 70 are sandwiched from the up and down directions, thereby fixing the film substrate 70. This allows a pulling tension to be applied between the right and left metallurgical tools 75, thereby enlarging the film substrate 70. In addition thereto, the film substrate 70 may also be enlarged using some other method such as increasing the temperature of the film substrate 70. In this way, it is preferable that, in the state where the film substrate 70 is extended in the one-axis direction, the position alignment be performed so that the alignment marks 72 on the film substrate 70 and the target marks 74 on the glass substrate 11 will be overlaid on each other.

As explained so far, on the glass substrate 11, the following configuration components are formed sequentially: The signal wirings 15 composed of Al, the inter-layer insulating layers 17 composed of SiN, the thin-film scanning wirings 14 formed of the Cr—Al multi-layered structure, the MIM insulating layers 16 composed of aluminum oxide, and the MIM elements 12 including the upper electrodes 13 formed of the Au—Ir multi-layered thin film. After that, the scanning-wiring buses 21 are pasted and fixedly bonded on the thin-film scanning wirings 14 via the electrically-conductive adhesive layers 20. The spacers 23 are bonded on the scanning-wiring buses 21 by the spacer adhesive layers 22 composed of the flit glass to which electrical conductivity is added.

### Embodiment 2

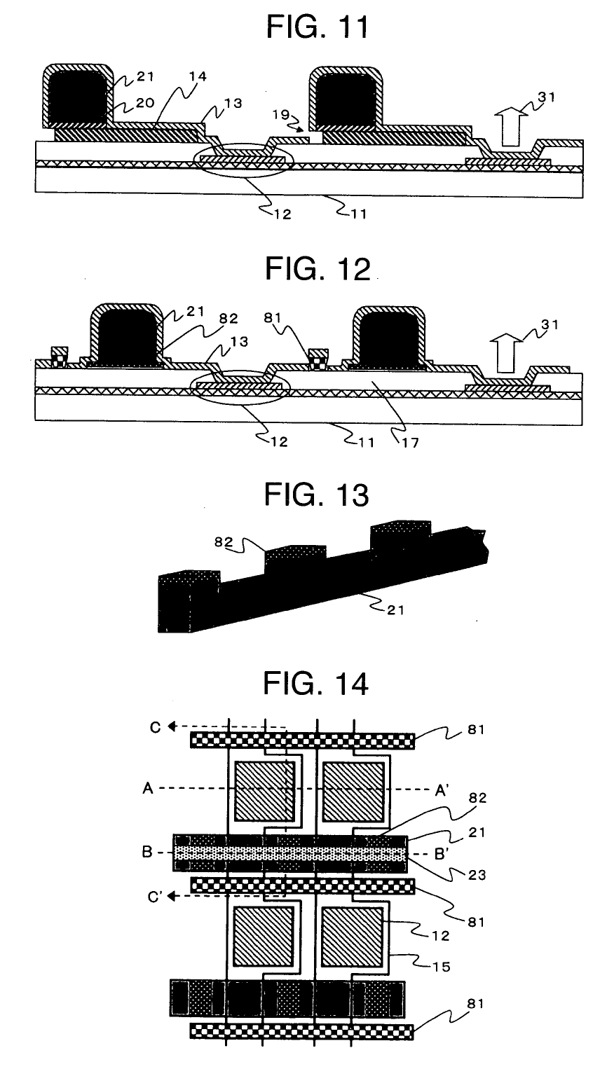

FIG. 11 is a configuration diagram where the structure of each thin-film scanning wiring 14 in the first embodiment is simplified. In comparison with FIG. 1 of the first embodiment, each thin-film scanning wiring 14 is formed into a single-layered structure. Moreover, one end portion of each scanning-wiring bus 21 is located in such a manner as to extend off from one end portion of each thin-film scanning wiring 14. This location results in formation of an over-hang structure. Then, the separation portions 19 having this over-hang structure implement step-height cutting of the upper electrodes 13 to be formed on the thin-film scanning wirings 14 and the scanning-wiring buses 21. This step-height cutting permits implementation of the structure where the upper electrodes 13 are separated. The configuration presented in this way makes it possible to configure each thin-film scanning wiring 14 with the single layer, thereby resulting in an advantage of being capable of simplifying the manufacturing steps.

### Embodiment 3

FIG. 12 is a simplified structure diagram where each thin-film scanning wiring 14 in the first embodiment is configured with each scanning-wiring bus 21 alone. In comparison with FIG. 1 of the first embodiment, the configuration is that each thin-film scanning wiring 14 is omitted, and that each scanning wiring 43 is formed with each scanning-wiring bus 21 alone.

In the present embodiment, the thin-film scanning wirings 14 need not be formed. This makes it possible to simplify the manufacturing steps significantly. At this time, in order to separate the upper electrodes 13 on each scanning-wiring-43 basis, separation layers 81 based on resist patterns located in parallel to the scanning wirings 43 are provided. This allows formation of over-hang structures, and implementation of step-height cutting.

If the separation layers 81 are exfoliated after the formation of the upper electrodes 13, it becomes possible to separate the upper electrodes 13 more securely. Also, in substitution for providing the separation layers 81, it is also preferable to separate the upper electrodes 13 by machining the inter-layer insulating layers 17 to providing concave portions in parallel to the scanning-wiring buses 21.

Also, in this configuration, it is advisable whether heat-resistant adhesive layers 82 for pasting the scanning-wiring buses 21 are of electrically-conductive property or insulating property. Furthermore, the heat-resistant adhesive layers 82 are formed in such a manner as to extend off from the scanning-wiring buses 21. This allows the scanning-wiring buses 21 and the upper electrodes 13 formed on the MIM elements 12 to be connected to each other in an excellent electrically-conductive state.

### Embodiment 4

FIG. 13 to FIG. 18 are diagrams of a configuration for reducing capacity between the scanning wirings 43. As Illustrated in FIG. 13, concave portions are provided in each scanning-wiring bus 21, and the heat-resistant adhesive layers 82 are formed on convex portions alone. The concave portions can be formed by precise press.

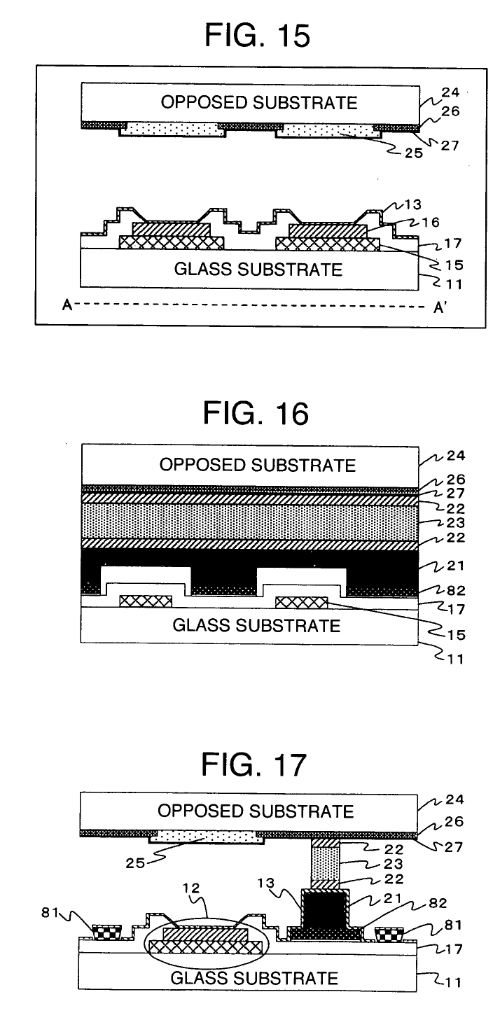

FIG. 14 is a plan view of the pixel portion 45 illustrated in FIG. 2, where each scanning-wiring bus 21 is located. Although FIG. 14 corresponds to FIG. 3, each signal wiring 15 is made narrower in portions other than the periphery of each MIM element 12, and the position of the cross section C-C′ differs. FIG. 15, FIG. 16, and FIG. 17 illustrate cross-sectional diagrams along lines A-A′, B-B′, and C-C′, respectively. FIG. 15 is the same as the A-A′ cross-sectional diagram in FIG. 3.

As Illustrated in FIG. 16, a spacing is formed around each signal wiring 15 by the concave-portion depth of each scanning-wiring bus 21 and thickness of the heat-resistant adhesive layers 82. The spacing lowers inter-layer capacity between each scanning-wiring bus 21 and each signal wiring 15, thereby resulting in none of a disturbance of the image due to wiring delay, and allowing upsizing of the display device. Also, the spacing tremendously decreases defects in intersection portions between each scanning-wiring bus 21 and each signal wiring 15 as Illustrated in FIG. 5, thereby making it possible to acquire excellent no-defect display. The structure that each scanning-wiring bus 21 is sufficiently thicker than each signal wiring 15 allows the implementation of this configuration.

As Illustrated in FIG. 17, each scanning wiring 43 Illustrated in FIG. 6 is formed with each scanning-wiring bus 21 alone, and also the separation layers 81 are provided. Each spacer 23 is fixedly bonded by the spacer adhesive layers 22 positioned at both ends thereof.

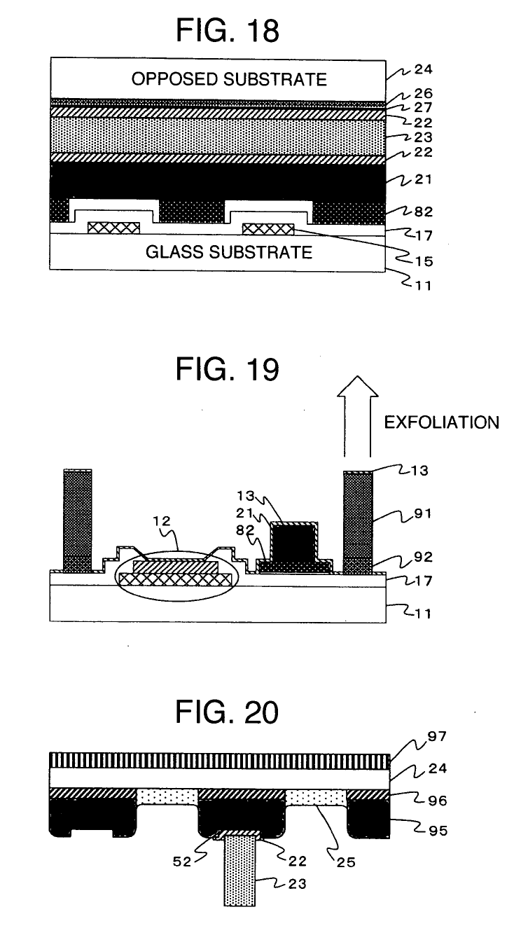

Incidentally, in substitution for the configuration Illustrated in FIG. 16, as Illustrated in FIG. 18, if the film thickness of the heat-resistant adhesive layers 82 is thicker than the film thickness of each signal wiring 15, the similar effects can also be acquired by partially forming the heat-resistant adhesive layers 82 alone even if no concave portions exist in each scanning-wiring bus 21. In this case, the concave portions are unnecessary, which makes it possible to easily acquire low-capacity and small-defect display.

### Embodiment 5

So far, the explanation has been given concerning the configuration that the scanning-wiring buses 21 are formed by pasting the metallic wiring patterns 71 illustrated in FIG. 7 and FIG. 8. Hereinafter, as a configuration to be applied to the FED display device 40 in accordance with the similar process, the explanation will be given below regarding an embodiment of the separation structure for separating the upper electrodes 13. In substitution for the patterns of the separation layers 81 illustrated in the third embodiment, metallic separation patterns will be used by being transferred.

FIG. 19 is a cross-sectional diagram of metallic separation layers 91 and glutinous layers 92 as the separation structure. Although FIG. 19 corresponds to FIG. 17, the metallic separation layers 91 are pasted by the glutinous layers 92 after the scanning-wiring buses 21 have been formed. Here, height of the metallic separation layers 91 and the glutinous layers 92 is made higher than that of the scanning-wiring buses 21. After the upper electrodes 13 have been formed, the separation structure is exfoliated, thereby separating the upper electrodes 13. At this time, the metallic separation layers 91 are exfoliated from the glutinous layers 92 on which the layers 91 have been pasted. Even if some of the glutinous layers 92 remains, this presents no drawback because the separation of the upper electrodes 13 has been completed.

### Embodiment 6

FIG. 20 is a cross-sectional diagram of phosphor separation layers 95 and adhesive layers 96. Using the metallic wiring patterns 71 illustrated in FIG. 7 and FIG. 8, the phosphor separation layers 95 are pasted on the opposed substrate 24 by the adhesive layers 96. The metallic wiring patterns 71 illustrated in FIG. 7 and FIG. 8 can be formed in a thickness up to 300-μm thick. This makes it possible to form the phosphor separation layers 95 whose film thickness is thicker than that of the thick-film phosphor layers 25.

When forming the phosphor layers 25 by screen printing, the layers 25 can be completely separated on each dot basis even if the printing accuracy is low. This allows formation of the no-color-mixture and high-definition FED display device 40.

Also, in order to form the phosphor layers 25, it is possible to use the way of coating photosensitive-resin containing slurry to perform light exposure. Here, since the phosphor separation layers 95 exhibit light-shielding property, the light exposure is performed from the side of the glass substrate 11. This permits the phosphor layers 25 to be made solid and formed by patterning, i.e., a self-alignment process. Namely, only the phosphor on aperture portions without the phosphor separation layers 95 is solidified. Washing away unphotosensitized slurry after the light exposure permits execution of high-accuracy patterning.

After the phosphor layers 25 have been formed in this way, a thin film of aluminum, which becomes the anode 27, is evaporated onto the layers 25. Here, the phosphor separation layers 95 exhibit an exceedingly low resistance. This property prevents the phosphor from being charged even if the aluminum layer is thin, thereby permitting implementation of high-luminance display.

Also, light emission toward side surfaces of the phosphor layers 25 can be extracted by reflection. This results in an effect of increasing luminance in the front-surface direction. Furthermore, the film thickness of the phosphor layers 25 becomes uniform within each dot. As a result, luminance within each pixel becomes uniform, and life-expectancy of the phosphor becomes longer. This allows an enhancement in the phosphor excitation intensity, thereby increasing efficiency of the panel.

In whatever case, in the case of using the metallic phosphor separation layers 95, it becomes possible to suppress reflection of the phosphor separation layers 95 by locating a circular-polarization filter 97 on the opposite side to the glass substrate 11. This results in an advantage of being capable of acquiring excellent contrast in a bright place.

It should be further understood by those skilled in the art that although the foregoing description has been made on embodiments of the invention, the invention is not limited thereto and various changes and modifications may be made without departing from the spirit of the invention and the scope of the appended claims.

1. A display device comprising:
a substrate on which signal wirings, scanning wirings, and electron emission elements are formed, said scanning wirings intersecting with said signal wirings, and being formed by transferring wiring patterns formed on a film substrate and by bonding said wiring patterns fixedly via adhesive layers, said electron emission elements being connected to said signal wirings and said scanning wirings, and
an opposed substrate on which phosphor layers are formed in such a manner that said phosphor layers are opposed to said electron emission elements.

2. The display device according to claim 1, wherein each of said scanning wirings has a multilayered structure including both a thin-film scanning wiring and a scanning-wiring bus.

3. The display device according to claim 1, wherein each of said scanning wirings includes only a scanning-wiring bus.

4. The display device according to claim 2, wherein a concave portion is provided in said scanning-wiring bus.

5. A display-device manufacturing method, comprising the steps of:
forming signal wirings on a substrate,
forming scanning wirings on said substrate by transferring wiring patterns formed on a film substrate, said scanning wirings intersecting with said signal wirings,
forming electron emission elements on said substrate, said electron emission elements being connected to said signal wirings and said scanning wirings, and
providing an opposed substrate on which phosphor layers are formed in such a manner that said phosphor layers are opposed to said electron emission elements.

6. The display-device manufacturing method according to claim 5, wherein said transfer of said wiring patterns is performed by enlarging said film substrate in a pitch direction of said wiring patterns.

7. The display-device manufacturing method according to claim 5, wherein an edge portion of said scanning wirings has an over-hang structure.

8. The display-device manufacturing method according to claim 5, wherein said phosphor layers are formed after phosphor separation layers and adhesive layers formed on said film substrate have been transferred onto said opposed substrate.

9. The display device according to claim 3, wherein a concave portion is provided in said scanning-wiring bus.

10. The display-device manufacturing method according to claim 7, wherein, after metallic separation layers and glutinous layers formed on said film substrate have been transferred onto said substrate, said separation structure is formed by exfoliating said metallic separation layers and said glutinous layers.
